(19) United States
(12) Patent Application Publication
(10) Pub. No.: US 2009/0018900 A1
(43) Pub. Date: Jan. 15, 2009

(54) PARKING FACILITY CUSTOMER SERVICE AND ACCESS CONTROL SYSTEM

(75) Inventors: JOHN F. WALDRON, LOUISVILLE, KY (US); WAYNE S. LAUER, DRIPPING SPRINGS, TX (US); BRIAN HOLMES, Leander, TX (US); CHRISTOPHER PARSONS, AUSTIN, TX (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 12/137,506

(22) Filed: Jun. 11, 2008

Related U.S. Application Data
(60) Provisional application No. 60/943,123, filed on Jun. 11, 2007.

(51) Int. Cl. G06F 11/34; G07B 15/00

(52) U.S. Cl. 705/11; 705/13

(57) ABSTRACT

A parking access control system and a method of its operation in association with a parking facility. A customer operates a call box to initiate a communications session with an attendant control device operated by an attendant. In particular, the customer requests the attendant to control an exit gate so as to enable the customer to exit the parking facility with a vehicle. In response, the attendant may input into the attendant control device one of several available predetermined override conditions, which will be logged as an override transaction entry in a database in memory. After the override condition is entered, then the exit gate will operate so as to enable the customer to exit the parking facility. The override transaction entry further may also include an identification of the attendant.

### CROSS-REFERENCE TO RELATED APPLICATIONS

This application claims the benefit and filing priority of U.S. application Ser. No. 60/943,123 filed Jun. 11, 2007.

### TECHNICAL FIELD

This invention relates to access control systems for parking facilities, and in particular to an access control system that provides an attendant audit capability so that attendants' actions may be closely monitored, tracked and reconciled.

### BACKGROUND OF THE INVENTION

The parking industry suffers revenue losses associated with mistakes and thefts by facility attendants. For example, a parking facility attendant may allow certain customers to exit a facility without making payment by simply opening the exit gates. In addition, there does not currently exist a manner of linking information in the revenue control system with actions by attendants as they are serving customers to create an audit trail of an attendant's actions, or linking the attendants' customer service actions to the transaction information. This problem is compounded by the fact that there are dozens of revenue control vendors, each operating proprietary systems unable to easily communicate to one another or to a central monitoring location. Parking facilities have had self-pay capability for several years, but have not had a mechanism to automate consolidation of attendants and their actions in serving customers.

### DISCLOSURE OF THE INVENTION

The present invention is therefore a parking access control system and a method of its operation in association with a parking facility. In the event that a customer is unable to exit a facility after making the required payment, the customer operates a call box (e.g. near the exit gate) to initiate a communications session with an attendant control device operated by an attendant. In particular, the customer requests the attendant to control an exit gate so as to enable the customer to exit the parking facility with a vehicle. In response, the attendant may input into the attendant control device one of several available predetermined override conditions (such as the ticket is unreadable by the ticket reader), which will be logged as an override transaction entry in a database in memory. After the override condition is entered, then the exit gate will operate so as to enable the customer to exit the parking facility. The override transaction entry that is stored in memory further may also include an identification of the attendant for subsequent audit and analysis.

The attendant control device may be a mobile device that wirelessly communicates with the call box, or it may be in a fixed location. The communication between the call box and the attendant control device may be audio only, or it may also include a video component. Optionally, at least part of the communications session between the call box and the attendant control device may be recorded and stored in the memory for archival purposes. This allows, for example, a more detailed reconciliation for the exit gate override.

The communications session between the call box and the attendant control device may be a local communications session occurring over a local area network, wherein the attendant and the attendant control device are in near proximity to the parking facility. As an alternative, the communications session between the call box and the attendant control device may be a remote communications session occurring over a wide area network, wherein the attendant and the attendant control device are remotely located from the parking facility. This allows a central control station to interoperate for example over the Internet with a number of parking facilities across a large geographic area.

The parking facility access control system of the present invention thus includes a call box adapted to enable a customer to initiate a communications session; an attendant control device adapted to communicate with the call box; a memory for storing a database; and an access control server comprising an exit gate interface and interconnected to the call box, the attendant control device, and the memory. The access control server is configured to enable the call box to communicate with the attendant control device so that the customer may request an attendant operating the attendant control device to control an exit gate so as to enable the customer to exit the parking facility. The attendant control device is configured to enable an attendant to input one of a plurality of predetermined override conditions. The memory is configured to log in a database an override transaction entry including at least the override condition input by the attendant. The access control server is further configured to cause, via the exit gate interface, the exit gate to operate so as to enable the customer to exit the parking facility.

### BRIEF DESCRIPTION OF THE DRAWING

FIG. 1 is a system block diagram of the preferred embodiment of the present invention.

FIG. 2 illustrates a diagram of a network embodiment of he present invention.

FIG. 3 is a flowchart of the operation of the present invention.

### BEST MODE FOR CARRYING OUT THE INVENTION

The parking facility customer service and access control system of the preferred embodiment of the present invention operates as follows. The preferred embodiment of the invention facilitates and automates attendant operation of the customer service system, by (1) providing individual log-in for each attendant and an associated audit trail of actions that attendant has taken, (2) queuing and prioritizing of audio and video calls from customers, (3) prompting the attendant to process calls not yet answered, (4) presenting the attendant with a predetermined list of actions to be taken, (5) providing wireless access to calls in the queue via a mobile (handheld) device. This queue is synchronized to ensure no duplication of call processing or attendant confusion. The invention also provides communication and synchronization with the revenue control system to validate the action selected with the ticket information from the customer in question. The invention also enables and provides communications with one or more central call processing (or monitoring) centers via a wide area network connection to enable attendants to provide customer services and access control remotely of a local facility. This occurs seamlessly to customers of the facility.

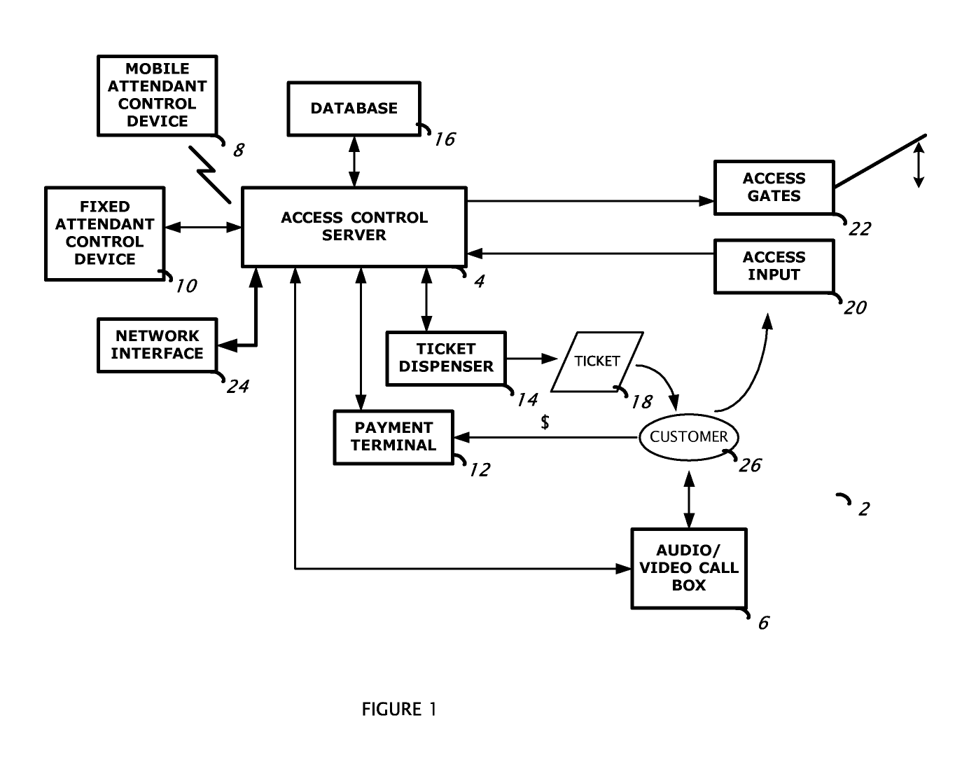

FIG. 1 illustrates a preferred embodiment system 2 of the present invention in basic topology. In FIG. 1, an access control server computer 4 is shown interconnected to various components of the parking facility. Access gates 22 are strategically located throughout the parking facility, and controlled directly or indirectly via the access control server 4. Access input devices 20 are also strategically located throughout the parking facility, typically in near proximity to an access gate 22. The access gates 22 and the access input devices 20 are usually located near the exits if the facility as known in the art.

One or more ticket dispensers 14 are located throughout the facility as well, typically near the entrance points of the facility. Payment terminals 12 are also strategically located, either near the exits and/or entrances of the facility.

Thus, for example as known in the prior art, a customer 26 drives into a parking facility and presses a button on the ticket dispenser 14 at the entrance point of the facility. The entrance time will be logged via the access control server, and then printed on the ticket 18 that is provided to the customer 26. After the customer 26 parks for a certain time, he will drive to the desired facility exit, where he will present the ticket to the access input terminal 20. The ticket's unique number is read and the access control server 4 ascertains the amount that is due to be paid based on the entry time and exit time. That amount is displayed to the customer 26, who then tenders payment such as by swiping a credit card into the associated payment terminal 12. Once proper payment is confirmed by the access control server 4, an exit signal is sent to the exit/access gate to enable the customer to drive out of the facility. In a variation of this embodiment, the customer may prepay for a certain time window, such as 10 hours, at the time of entry to the facility (in which case the payment terminal is located at the entry point), or he may make payment prior to returning to his car (in which case a more centralized location for the payment terminal 12 is desired). In any event, this basic scenario or a variant thereof is executed as described.

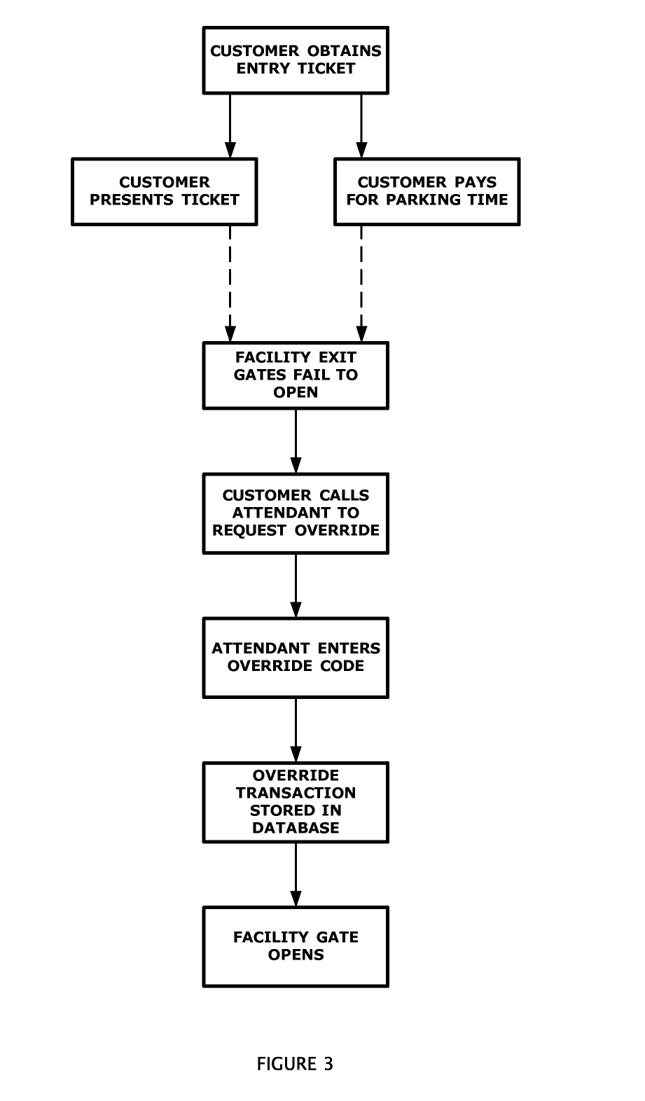

Problems may arise in the operation of this system, which necessitates he interaction with the present invention as will now be described (see also the flowchart of FIG. 3). A facility attendant is provided with an attendant control device that enables him or her to interact with the system. This may be a fixed location attendant control device 10, or it may be a mobile attendant control device 8. By using a mobile device 8, the attendant need not remain at a fixed location, and may roam around the parking facility to execute other tasks as may be required. There are also one or more call boxes 6 strategically located throughout the parking facility, in particular at each entrance and exit point of the facility. The call box 6 may be an audio call box, or it may also provide video streaming capabilities if desired.

In any event, the customer may initiate a communication with an attendant at any time by simply operating the call box 6. This will cause the access control server to request an attendant to respond via an attendant control device 8, 10. For example, a customer may find that the access input device 20 is not properly reading his ticket as he attempts to exit the facility. If this occurs, he will press a button the call box 6 located at that exit point. A request is then sent from the call box 6 to the access control server 4, which will request (for example) the mobile attendant control device 8 to respond. The customer may then simply speak and tell the attendant that his ticket is not being read. The attendant may then ask the customer to read to him his ticket number, which the attendant can then enter into the mobile attendant control device 8. A request will be sent to the access control server to verify that this ticket has been properly paid for, and if so the access control server will respond accordingly. Once the attendant sees that the customer has in fact paid for the parking, he can select an override condition (also called a “reason code”) from a drop down list on the attendant control device. This will cause the exit gate 22 to be overridden and to open for the customer and enable him to drive away. The override transaction will then be logged in a database memory 16 for subsequent reconciliation and review. Additional override conditions (reason codes( are provided further below.

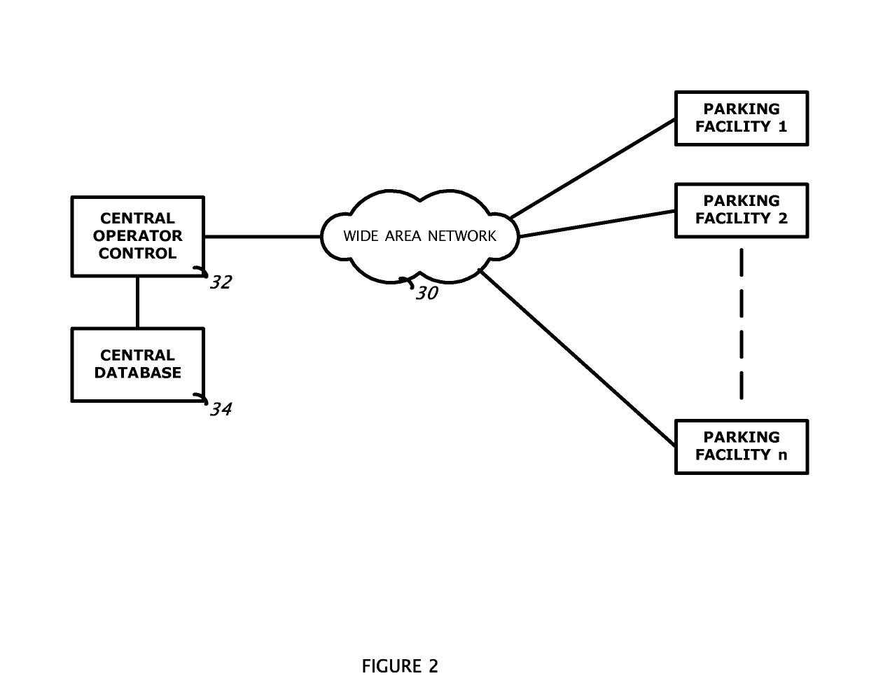

In a second embodiment, attendant interaction is done remotely rather than locally. FIG. 2 illustrates this concept, wherein a number of geographically distinct parking facilities (parking facility 1, parking facility 2, . . . parking facility n) are interconnected via a network interface 24 to a wide area network 30 such as the Internet) to a centrally located operator control station 32 and central database 34. This enables a central attendant to control and interact with a number of remotely located parking facilities in the same manner as described above.

In addition to logging the specific override condition selected by the attendant, the identification of the attendant (e.g. an employee number or the like) is also logged, so that it can be determined which attendant is allowing which overrides over the course of a certain time. Similarly, the communications between the attendant and the customer may be logged as well (e.g. a digitized voice session) to confirm the need for an override event.

Thus, the parking garage attendant control system provides a roaming two-way audio connection between a call box at the exit gate (or standalone call boxes), and the parking garage attendant. The system through the access control server manages calls, routes information to the attendant, and allows the attendant to control the exit gates 22 from his mobile position via a data interface with the access control system. The system also queues video display, digital video recording, and serving of IP video events in and from the parking garage office. The system 2 of the preferred embodiment may be offered with the functional software and hardware options shown in Table 1:

TABLE 1
Parking Garage Attendant Control System Options

| | Description | Installed At |
|---|---|---|
| Hardware Option | | |
| Ethernet 100BaseT | 100BaseT Network | Field |
| Video Call Box | NEMA 4 enclosure with | Factory (except |
| | Electret Microphone, | retrofit kit) |
| | weatherproof Speaker, | |
| | Call Button, Talk Light, | |
| | Video/Audio Server, and | |
| | Optional UPS | |
| Video Call Box | Electret Microphone, | Field |
| Retrofit Kit | Weatherproof Speaker, | |
| | Call Button, Talk Light, | |
| | Video/Audio Server | |
| Wireless Access Point | 802.11g capable wireless | Field |
| | access point with | |
| | connectivity to 100 | |
| | BaseT Network | |
| Mobile Attendant PDA | 802.11g capable | Factory Only |
| | Handheld Computing | |
| | Device | |
| Office Server | Capable of handling | Field |
| | operation of the | |
| | attendant software, | |
| | digital video recording | |
| | and video management | |
| | system, and providing | |
| | interface service to | |
| | garage auditing system | |
| | for gate control. | |
| Software Option | | |
| Video Management | Display, archive and | Factory or Field |
| Application | retrieve CCTV video for | |
| | system IP cameras. | |
| Attendant Application | Parking garage attendant | Factory or Field |
| | control and management | |
| Audit System Gate | Interface to accounting | Factory |
| Controller Interface | audit system for | |
| Service | communicating attendant | |
| | action codes controlling | |
| | gates for exiting | |
| | vehicles. | |

The system features may be summarized as follows:
Voice Over IP Communications
   Handheld PDA voice communications
   Console intercom
   Call queing
Digital Video Management
   Networkable video server
      Open system architecture for national call center control
      IP and analog camera compatibility
Mobile and Base Attendant Control
   Password protection
   Reason codes for positive audit controls
   Location codes
Standard interface service protocols to most revenue/access control systems
802.11 g wireless compatibility

Type 1 Video/Audio Call Box

Non-kit call boxes are built from weatherproof NEMA qualified enclosures mounted conveniently at the vehicle exit gates. The box contains a video server that provides connectivity for audio, video and signaling via BaseT Ethernet. If BaseT wiring is not practical, the call box may be served via the wireless LAN at a higher cost.

Type I enclosure to house the following components

1) Push-to-talk button, 2) powered speaker with utility amplifier (w/automatic level control), 3) powered electret microphone, 4) audio/video streamer for connection of camera and speaker, microphone, 5) indicator LED kit.

Includes capability of interfacing to fixed video cameras and providing two-way VoIP communications with the parking garage attendant. Cameras are fixed, but they could be optioned for PTZ cameras at a higher cost Cameras will be deployed external to the call box.

Type 2 Call Box Kit

A kit to be installed in the ticket reader box at vehicle exit stations. Items included in this kit are: 1) Push-to-talk button, 2) powered speaker with automatic level control, 3) powered electret microphone, 4) audio/video streamer for connection of camera and speaker, microphone, 5) indicator LED kit.

Each call box and kit has a single rugged push to call button that the vehicle driver can actuate to signal the attendant and initiate a transaction. Both types of call boxes have a single ruggedized status indicator that flashes when waiting for the attendant's response, and becomes steady while the transaction is in progress and the attendant is connected.

Once the attendant has answered the call, communication between the attendant and a call box occurs using two-way audio.

Each call box has an optional internal uninterruptible power supply with enough battery capacity to run the box for up to four hours at 32° F. without AC power. AC power status is signaled back to the office server and the attendant.

The Call Box Kit contains only the items that are installed in the video call box with the exception that no box is provided. The kit is to be installed in a unit such as the one below by its manufacturer.

Attendant Interface (Fixed and Mobile)

The attendant interface is via either a hand held personal digital assistant (PDA) or at the video file server console located in the garage office. The office or fixed console (server) will be connected to the system via a 1000 Base T network, a 1 Gb Ethernet switch, and a 1 Gb Network Interface Card (NIC). The PDA data connection is via standard wireless access points positioned throughout the garage to insure adequate reception.

The Attendant Interface is provided with special application code that allows the operator to respond to calls and speak with customers. The following capabilities are required at both the fixed position and the mobile attendant units:

1. Method button for answering a call from a particular video/call box.

2. Display for identifying call box location.

3.Queue for identifying additional unanswered incoming calls.

4. Password operator/attendant login.

5. Drop down menu for display of operator available methods.

6. Drop down menu for display of operator reason codes.

7. Display window for snapshot of vehicle drive being transmitted via CCTV camera.

8. Display error message sent from auditing system.

A streamlined graphical user interface guides the attendant in making the choices regarding customer disposition without having to remember or learn numeric codes.

The Attendant Interface's for both fixed locations and mobile device should be nearly identical as possible in form and functionality.

Below in Table 2 are the reason codes required for this application:

TABLE 2

| | Reason | | |
|---|---|---|---|
| Reason | Code | Input | Action |
| Lost Ticket | 01 | None | Initiate Bail Out |
| Unreadable Paid Ticket | 02 | Transaction Number | Open Exit Gate |
| Unreadable Unpaid Ticket | 03 | None | Initiate Bail Out |
| Employee - With Ticket | 04 | Transaction Number | Open Exit Gate |
| Maintenance - With Ticket | 05 | Transaction Number | Open Exit Gate |
| Vendor - With Ticket | 06 | Transaction Number | Open Exit Gate |
| No Park - Grace Period Expired | 07 | Transaction Number | Open Exit Gate |
| Paid Ticket - Grace Period Expired | 08 | Transaction Number | Open Exit Gate |
| Left Ticket in Paystation | 09 | None | Open Exit Gate |
| Validation Failed | 10 | None | Initiate Bail Out |
| Car in Tow | 11 | None | Open Exit Gate |
| Declined Credit Card | 12 | None | Initiate Bail Out |
| Monthly Customer in | 13 | Transponder/Card | Open Exit or Entry |
| Passback | | Number | Gate |
| Monthly Customer with | 14 | Transponder/Card | Initiate Bail Out |
| Voided Card | | Number | |
| Monthly - No Access Device | 15 | Transaction Number | Open Exit Gate |
| w/ Ticket | | | |
| Valet - Ticket in Passback | 16 | Ticket Number | Open Exit or Entry |
| | | | Gate |
| Hotel Guest - Ticket in | 17 | Ticket Number | Open Exit or Entry |
| Passback | | | Gate |
| Valet - Expired Ticket | 18 | Ticket Number | Open Exit or Entry |
| | | | Gate |
| Hotel Guest Self Park - | 19 | Transaction Number | Initiate Bail Out |
| Expired Ticket | | | |
| Hotel Visitor - Expired Ticket | 20 | Transaction Number | Initiate Bail Out |

Wireless Access Point (WAP)

Each wireless access point is housed in a NEMA class enclosure with a 4-hour uninterruptible power supply. Wireless transmission is provided via an omni-directional antenna mounted external to the NEMA box.

The wireless access points connect to the backbone 100 BaseT infrastructure that connects the call boxes and the garage office server via a 1 Gb Ethernet Switch.

One or many units may be required depending on the radio environment of the garage to assure adequate wireless coverage throughout the garage.

Wireless access point should provide at a minimum, 802.11 g communications.

Office Server (Access Control Server)

The office server is a personal rack mounted computer that is provided with one or multiple (two or three) LCD displays and keyboard. Application software is provided that records associated call box transactions including audio, and video where applicable. This information is archived and may be examined using a forensic review application at the server, or optionally over the Internet if provisioned. The office server includes a service program that communicates with the gate auditing system via TCP/IP. Attendant decisions made via the PDA or at the office server are forwarded to the auditing system to actuate gates and other logging. The office server therefore acts as a gateway between the PDA and the auditing system.

The office server is located in an environmentally friendly location (indoor) and requires no special heating or cooling for operation. It will be rack mounted and will be relatively protected from tamper, vandalism, and harsh temperatures or weather.

Video/CCTV Requirements

Recording of any camera and stored for a period of 1 month.

PTZ will be independent of recording or audio, and or PDA functionality (manual override and control for PTZ).

Capability to simultaneously record up to 10 cameras.

It is not anticipated that more than 10 cameras will be queued simultaneously.

When storage capacity is reached, write over files started with the oldest files first.

Operator should be able to review one month's archives and create CD's of selected files.

An exemplary transaction executed with this invention has four phases:

1. Call request by vehicle operator

2. Call acceptance by the attendant

3. Attendant decision

4. Audit system notification and call termination

A transaction begins when a driver pushes the attendant call button. The button actuation is signaled to the office server that responds by sending back a command to flash the call box status indicator. The status indicator remains flashing until the call is accepted by the attendant. Video from call box associated cameras is sent to the office server for archive. Bandwidth restrictions may limit the number of simultaneous video recordings of call requests. Priority is given to accepted calls over pending requests.

The office server also alerts the attendant by signaling a call request via the PDA sonic and display. If the office server attendant application is running, the same occurs on the server's console. The office server queues multiple call requests and prompts the attendant to deal with them in the order received. The attendant application allows the user to respond to call requests in any order if necessary.

Once the attendant picks a call to service, a connection is established to the selected call box server. The call box status light illuminates steadily to indicate a call acceptance. The attendant can then talk with the vehicle driver and determine the course of resolution. The attendant selects a resolution procedure from a multiple-choice list where he is guided to obtain the information necessary for meeting garage policy. At the conclusion of the procedure, the auditing system is provided with the information necessary for concluding the transaction. The audio connection ends, and a record of the transaction is saved with links to any streaming media files on the office server.

What is claimed is:

1. A method of operating a parking access control system in association with a parking facility comprising:
a. a customer operating a call box to initiate a communications session with an attendant control device operated by an attendant;
b. the customer requesting the attendant to control an exit gate so as to enable the customer to exit the parking facility with a vehicle;
c. the attendant inputting into the attendant control device one of a plurality of predetermined override conditions;
d. logging an override transaction entry in memory comprising at least the override condition input by the attendant; and
e. causing the exit gate to operate so as to enable the customer to exit the parking facility.

2. The method of claim 1 wherein the override transaction entry further comprises an identification of the attendant.

3. The method of claim 1 wherein the attendant control device is a mobile device that wirelessly communicates with the call box.

4. The method of claim 1 wherein the communication between the call box and the attendant control device comprises an audio signal.

5. The method of claim 4 wherein the communication between the call box and the attendant control device further comprises a video signal.

6. The method of claim 1 wherein at least part of the communications session between the call box and the attendant control device is recorded and stored in the memory.

7. The method of claim 1 wherein the predetermined override conditions are presented to the attendant on the attendant control device in a drop down list format.

8. The method of claim 1 wherein the communications session between the call box and the attendant control device is a local communications session occurring over a local area network, wherein the attendant and the attendant control device are in near proximity to the parking facility.

9. The method of claim 1 wherein the communications session between the call box and the attendant control device is a remote communications session occurring over a wide area network, wherein the attendant and the attendant control device are remotely located from the parking facility.

10. A parking facility access control system comprising:
a. a call box adapted to enable a customer to initiate a communications session;
b. an attendant control device adapted to communicate with the call box;
c. a memory for storing a database; and
d. an access control server comprising an exit gate interface and interconnected to the call box, the attendant control device, and the memory;
wherein the access control server is configured to enable the call box to communicate with the attendant control device so that the customer may request an attendant operating the attendant control device to control an exit gate so as to enable the customer to exit the parking facility;
the attendant control device is configured to enable an attendant to input one of a plurality of predetermined override conditions;
the memory is configured to log in a database an override transaction entry comprising at least the override condition input by the attendant; and
the access control server is further configured to cause, via the exit gate interface, the exit gate to operate so as to enable the customer to exit the parking facility.

11. The parking facility access control system of claim 10 wherein the override transaction entry further comprises an identification of the attendant.

12. The parking facility access control system of claim 10 wherein the attendant control device is a mobile device that wirelessly communicates with the call box.

13. The parking facility access control system of claim 10 wherein the communication between the call box and the attendant control device comprises an audio signal.

14. The parking facility access control system of claim 13 wherein the communication between the call box and the attendant control device further comprises a video signal.

15. The parking facility access control system of claim 10 wherein at least part of the communications session between the call box and the attendant control device is recorded and stored in the memory.

16. The parking facility access control system of claim 10 wherein the predetermined override conditions are presented to the attendant on the attendant control device in a drop down list format.

17. The parking facility access control system of claim 10 wherein the communications session between the call box and the attendant control device is a local communications session occurring over a local area network, wherein the attendant and the attendant control device are in near proximity to the parking facility.

18. The parking facility access control system of claim 10 wherein the communications session between the call box and the attendant control device is a remote communications session occurring over a wide area network, wherein the attendant and the attendant control device are remotely located from the parking facility.
